(19) United States
(12) Patent Application Publication
(10) Pub. No.: US 2025/0156305 A1
(43) Pub. Date: May 15, 2025

(54) METHOD AND APPARATUS FOR RECORDING TEST CASE, STORAGE MEDIUM, AND COMPUTER DEVICE

(71) Applicant: GUANGZHOU PINWEI SOFTWARE CO., LTD., Guangzhou (CN)

(72) Inventor: Chaoyong CHEN, Guangzhou (CN)

(73) Assignee: GUANGZHOU PINWEI SOFTWARE CO., LTD., Guangzhou (CN)

(21) Appl. No.: 18/733,926

(22) Filed: Jun. 5, 2024

(30) Foreign Application Priority Data
Nov. 13, 2023 (CN) 202311499038.3

(51) Int. Cl. G06F 11/36

(52) U.S. Cl. CPC G06F 11/3684

(57) ABSTRACT

A method and apparatus for recording a test case, a storage medium, and a computer device are provided. With the method, case information groups corresponding to a target application program are obtained, each of the case information groups includes a case label and a case requirement. A case selection box is generated by using case labels from the case information groups as candidates. In response to a record starting operation of a user and if one of the case labels is selected, a target case information group corresponding to the selected case label is determined from the case information groups, and test action data is obtained. In response to a record stopping operation of the user, obtaining of the test action data is stopped, and a target test case is generated based on obtained test action data and the target case information group.

This application claims priority to Chinese Patent Application No. 202311499038.3, titled “METHOD AND APPARATUS FOR RECORDING TEST CASE, STORAGE MEDIUM, AND COMPUTER DEVICE”, filed on Nov. 13, 2023, with the China National Intellectual Property Administration (CNIPA), which is incorporated herein by reference in its entirety.

### FIELD

The present disclosure relates to the technical field of software testing, and in particular to a method and an apparatus for recording a test case, a storage medium and a computer device.

### BACKGROUND

In a process of testing a to-be-tested application program, relevant tests may be performed on the application program by using a test case, which can realize the process of testing the application program in a manageable mode, and evaluate a test result accurately and effectively, so that a blind testing is avoided and a testing efficiency is improved. Recording of a test case refers to a process of capturing test action data, generating executable codes, and obtaining a test case performed when a user tests an application program according to a functional test requirement. The testing action may be performed repeatedly by playing back the recorded test case, so as to achieve an automated test and improve an efficiency of testing the application program.

In the conventional technology, recording of a test case has a high error rate and is time consuming, which results in a reduced efficiency of recording a test case.

### SUMMARY

The present disclosure is provided to solve at least one of the aforementioned technical problems, particularly the problem of the low efficiency of recording a test case in the conventional technology.

In a first aspect, a method for recording a test case is provided in the present disclosure. The method includes:
obtaining, from a pre-established test case management system, case information groups corresponding to a target application program, where each of the case information groups includes a case label and a case requirement;
generating a case selection box by using case labels from the case information groups as candidates;
determining, in response to a record starting operation of a user and in a case where one of the case labels is selected, a target case information group corresponding to the selected case label from the case information groups, and obtaining test action data; and
stopping obtaining the test action data in response to a record stopping operation of the user, and generating a target test case based on the obtained test action data and the target case information group.

In an embodiment, the obtaining, from a pre-established test case management system, case information groups corresponding to a target application program includes:
determining test versions of the target application program and determining, from the test case management system, functional identifications corresponding to the test versions; and
extracting, for each of the functional identifications, a case information group corresponding to the functional identification from the test case management system.

In an embodiment, the generating a case selection box by using case labels from the case information groups as candidates includes:
extracting case labels from the case information groups, and sorting the case labels based on case numbers in the case labels; and
generating the case selection box by using the sorted case labels as candidates.

In an embodiment, the obtaining test action data includes:
detecting multiple probes preset in the target application program, where each of the probes is configured to identify a function name in the target application program; and
determining, in a case where a target executable statement in the target application program is executed, a target probe corresponding to the target executable statement and recording a target function name corresponding to the target probe, where the target executable statement is an executable statement in a function module of the target application program.

In an embodiment, after the step of stopping obtaining the test action data in response to a record stopping operation of the user, and generating a target test case based on obtained test action data and the target case information group, the method further includes:
establishing, based on the recorded target function name, a correlation between the recorded target function name and the target test case; and
calculating a percentage of a number of recorded target function names to a total number of all target function names, to obtain a test coverage of the target test case.

In an embodiment, the method further includes:
determining, in a case that one of the case labels is selected, a target case information group corresponding to the selected case label from the case information groups; and
displaying, in the case selection box, case information content in the target case information group.

In an embodiment, the method further includes:
sending, in response to the record starting operation, an alert to a user in a case where none of the case labels is selected.

In a second aspect, an apparatus for recording a test case is provided in the present disclosure. The apparatus includes: a case information group obtaining module, a case selection box generating module, a target case information group determining module, and a target test case generating module. The case information group obtaining module is configured to obtain, from a pre-established test case management system, case information groups corresponding to a target application program, where each of the case information groups includes a case label and a case requirement. The case selection box generating module is configured to generate a case selection box by using case labels from the case information groups as candidates. The target case information group determining module is configured to determine, in response to a record starting operation of a user and in a case where one of the case labels is selected, a target case information group corresponding to the selected case label from the case information groups, and obtain test action data. The target test case generating module is configured to stop obtaining the test action data in response to a record stopping operation of the user, and generate a target test case based on obtained test action data and the target case information group.

In a third aspect, a storage medium is provided in the present disclosure. The storage medium stores a computer-readable instruction. The computer-readable instruction, when executed by one or more processors, causes the one or more processor to perform the method for recording a test case according to any of the above embodiments.

In a fourth aspect, a computer device is provided in the present disclosure. The computer device includes one or more processors and a memory. The memory stores a computer-readable instruction, and the computer-readable instruction, when executed by the one or more processors, performs the method for recording a test case according to any of the above embodiments.

From the above technical solutions, the present disclosure has the following advantages. With the method and apparatus for recording a test case, the storage medium, and the computer device provided in the present disclosure, case information groups corresponding to a target application program are obtained from a pre-established test case management system, each of the case information groups includes a case label and a case requirement. A case selection box is generated by using case labels from the case information groups as candidates. In response to a record starting operation of a user and in a case where one of the case labels is selected, a target case information group corresponding to the selected case label is determined from the case information groups, and test action data is obtained. In response to a record stopping operation of the user, obtaining of the test action data is stopped, and a target test case is generated based on obtained test action data and the target case information group. In this way, the test case to be recorded can be selected from the selection box during a process of recording a test case, thereby reducing an error rate and the time for a user to record a test case, thus improving an efficiency of recording a test case.

### BRIEF DESCRIPTION OF THE DRAWINGS

For clearer illustration of the technical solutions according to embodiments of the present disclosure or conventional techniques, hereinafter briefly described are the drawings to be applied in embodiments of the present disclosure or conventional techniques. Apparently, the drawings in the following descriptions are only some embodiments of the present disclosure, and other drawings may be obtained by those skilled in the art based on the provided drawings without any creative effort.

FIG. 1 is a schematic flowchart showing a method for recording a test case according to an embodiment of the present disclosure;

FIG. 2 is a schematic flowchart showing a process of obtaining a case information group according to an embodiment of the present disclosure;

FIG. 3 is a schematic flowchart showing a process of generating a case selection box according to an embodiment of the present disclosure;

FIG. 4 is a schematic flowchart showing a process of obtaining test action data according to an embodiment of the present disclosure;

FIG. 5 is a schematic structural diagram of an apparatus for recording a test case according to an embodiment of the present disclosure; and

FIG. 6 is a schematic structural diagram of a computer device according to an embodiment of the present disclosure.

### DETAILED DESCRIPTION

Hereinafter technical solutions of embodiments of the present disclosure are described clearly and completely in conjunction with the drawings of the embodiments of the present disclosure. Apparently, the embodiments described below are only some embodiments, rather than all the embodiments of the present disclosure. Any other embodiments obtained by those skilled in the art based on the embodiments in the present disclosure without any creative effort shall fall within the protection scope of the present disclosure.

As mentioned in the background section, there is a technical problem of a low efficiency of recording a test case according to the conventional technology. It has been found that a reason for this problem is that: a user needs to manually input a test case ID to record a test case at present, however, there are a large number of test cases corresponding to a to-be-tested application program, and manual input of the test case IDs has a high error rate and is time consuming, thus an efficiency of recording a test case is decreased.

To solve the aforementioned problem, a method and apparatus for recording a test case, a storage medium, and a computer device are provided according to the present disclosure. According to the embodiments of the present disclosure, a test case to be recorded can be selected from the selection box during a process of recording a test case. In this way, an error rate is reduced and time for a user to record a test case is reduced, thereby improving an efficiency of recording a test case.

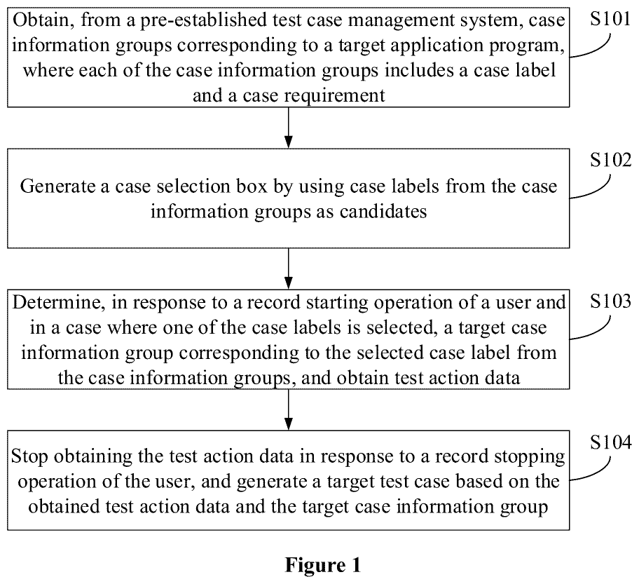

In an embodiment, a method for recording a test case is provided in the present disclosure. The embodiment is described in the following by using an example in which the method is applied to a computer device. It can be understood that the computer device may include, but is not limited to an individual server, a server cluster, a personal laptop, a desktop, and other devices having data processing functions. As shown in FIG. 1, the method for recording a test case of the present disclosure may include the following steps S101 to S104.

In step S101, case information groups corresponding to a target application program is obtained from a pre-established test case management system, where each of the case information groups includes a case label and a case requirement.

In this step, the test case management system records test information of at least one application program and a correlation between different pieces of test information in each application program. For example, the correlation may be a correlation between a test requirement and a function branch in a target application program, or a correlation between a functional identification and a case information group, or a correlation between a test requirement and a case information group. The target application program refers to an application program to be tested, which is not specifically limited in the present disclosure. Each case information group may include a case label and a case requirement. The case label is used for identifying the case information group. The case label is unique and has a one-to-one correspondence with the case information group. The case requirement is used for recording specific content required for recording and generating a test case. The case requirement includes but is not limited to a case level, an abstract, and a prerequisite, which is not specifically defined herein.

Specifically, in the test case management system, the case information group corresponding to a target application program may be determined based on the correlation between different pieces of test information in the target application program, so that the case information group can be obtained accurately.

In step S102, a case selection box is generated by using case labels from the case information groups as candidates.

In this step, case labels of the case information groups are extracted and used as candidates to generate the case selection box. A case label may include a case number and a case name. The case selection box is used for displaying the case labels for a user to select from.

In step S103, in response to a record starting operation of a user, and in a case where one of the case labels is selected, a target case information group corresponding to the selected case label is determined from the case information groups, and test action data is obtained.

In this step, in a case where the recording is started and a case label is selected by a user, the case information group corresponding to the case label is selected from the case information groups based on the selected case label, and test action data is obtained.

Further, the recording being started by the user refers to initiating recording of a test case. A method of starting the recording may be determined according to actual needs, which is not specifically limited herein. For example, the recording may be started by clicking a button or running a script. The obtaining test action data includes detecting a testing step in which the user tests the target application program, generating executable codes, and obtaining data generated during the testing process.

In step S104, in response to a record stopping operation of the user, obtaining of the test action data is stopped, and a target test case is generated based on obtained test action data and the target case information group.

In this step, if the recording is stopped by the user, obtaining of the test action data is stopped, and the target test case is generated based on the test action data obtained during the recording process and the target case information group. The target application program can be automatically tested by playing back the target test case. The test action data refers to data generated while the user testing the target application program. For example, the test action data may be executable codes generated in a testing step of the user, or may be the number of codes executed in the target application program.

Further, the recording being stopped by the user refers to stopping recording of a test case. A method of stopping the recording may be determined according to actual needs, which is not specifically limited herein. For example, the recording may be stopped by clicking a button or running a script. The target test case may be generated by combining the obtained test action data and the target case information group.

With the method for recording a test case provided in the present disclosure, a test case to be recorded can be selected from the selection box during a process of recording a test case. In this way, an error rate is reduced and the time for a user to record a test case is reduced, thereby improving an efficiency of recording a test case.

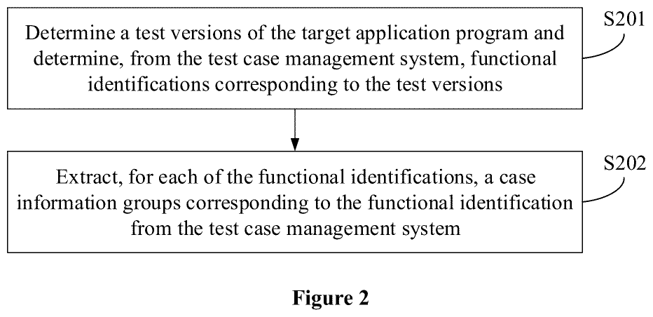

As shown in FIG. 2, in an embodiment, the step of obtaining, from a pre-established test case management system, case information groups corresponding to a target application program includes the following steps S201 to S202.

In step S201, test versions of the target application program are determined, and functional identifications corresponding to the test versions are determined from the test case management system.

In step S202, for each of the functional identifications, a test case information group corresponding to the functional identification is extracted from the test case management system.

Typically, an application program may have multiple versions. The test version of the target application program is determined, and correlations corresponding to the test version may be obtained in the test case management system, and the case information group corresponding to the target application program may be obtained based on the correlations, to ensure that the obtained case information group are for the target application program, thereby improving an accuracy of obtaining the case information group. In the test case management system, a functional identification corresponding to the test version is obtained based on the correlation between a test version and a functional identification. For each functional identification, a case information group corresponding to the functional identification may be obtained in the test case management system based on a correlation between a functional identification and a case information group.

It can be understood that after the test version of the target application program is determined, in the test case management system, the case information group can be obtained based on the correlation between a test version and a functional identification and the correlation between a functional identification and a case information group. Therefore, it can be ensured that all case information groups for the target application program are obtained, thereby reducing an error rate in recording a test case.

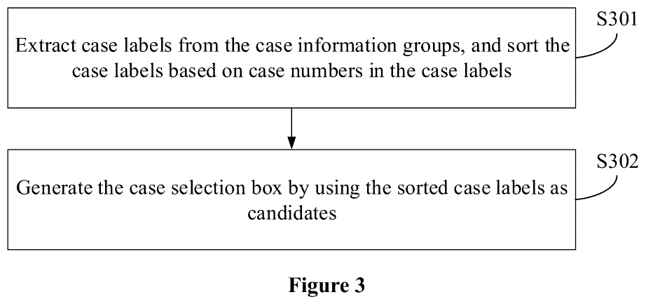

As shown in FIG. 3, in an embodiment, the step of generating a case selection box by using case labels from the case information groups as candidates includes the following steps S301 to S302.

In step S301, case labels are extracted from the case information groups, and the case labels are sorted based on case numbers in the case labels.

In step S302, the case selection box is generated by using sorted case labels as candidates.

Specifically, a case number in a case label is used for uniquely determining a case information group. The case number may be set according to actual needs, which is not specifically limited herein. For example, the case number may be a digit, a letter, or a combination thereof. In addition, the case numbers may have the same length or different lengths. The sorting may be performed according to actual needs, which is not specifically limited here. For example, the case labels may be sorted in a descending order, or in an ascending order.

It can be understood that sorting the case labels based on the case numbers allows the user to select a case label quickly and accurately for recording a test case, thereby reducing an error rate in recording of the test case and a user operation time, thus improving the efficiency of recording the test case.

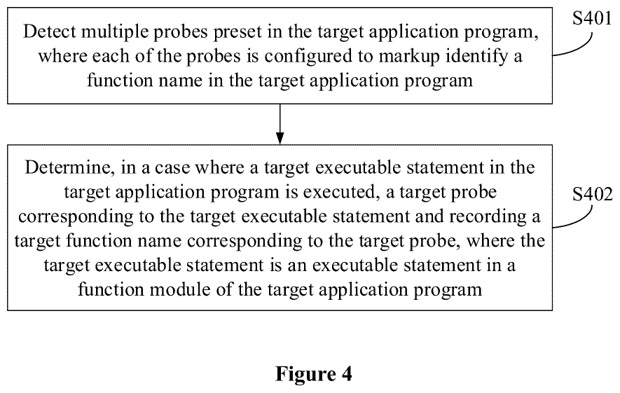

As shown in FIG. 4, in an embodiment, the step of obtaining test action data includes the following steps S401 to S402.

In step S401, multiple probes preset in the target application program are detected, where each of the probes is configured to identify a function name in the target application program.

In step S402, in a case where a target executable statement in the target application program is executed, a target probe corresponding to the executable statement is determined and a target function name corresponding to the target probe is recorded, where the target executable statement is an executable statement in a function module of the target application program.

It can be understood that in an application program, a function module usually includes multiple rows of executable statements, and the function module is considered to be executed when any one of the executable statements in the function module is executed. Therefore, by using a probe to identify the function name of the function module, the function name of the function module can be obtained directly when any of the executable statements in the function module is executed, so that the number of executed statements can be determined quickly, and a test coverage of test cases can be determined without having to determine the executed statements one by one. In this way, a speed of obtaining the action data is improved and the efficiency of recording a test case is improved.

In an embodiment, after the step of stopping obtaining, in response to a record stopping operation of the user, the test action data and generating a target test case based on obtained test action data and the target case information group, the method further includes:
establishing, based on the recorded target function name, a correlation between the recorded target function name and the target test case, and calculating a percentage of the number of recorded target function names to a total number of all target function names, to obtain a test coverage of the target test case.

It can be understood that by establishing the correlation between a recorded target function name and the target test case and calculating the percentage of the number of recorded target function names to a total number of all target function names, the test coverage of the target test case can be obtained. In this way, it is convenient for a user to view or verify the function module executed by the target test case and a testing completion degree of the target test case. In this way, a time for the user to evaluate a recording process of the target test case is reduced, thereby improving the efficiency of recording the test case.

In an embodiment, the method further includes:
determining, in a case where one of the case labels is selected, a target case information group corresponding to the selected case label from the case information groups, and displaying case information content of the target case information group in the case selection box.

It can be understood that in a case where one of the case labels is selected by a user, the target case information group corresponding to the case label is determined from the case information groups, and the case information content of the target case information group is displayed in the case selection box, for the user to verify the case information. In this way, it is ensured that the test case is generated correctly based on the action test data and the case information group during the recording process, so that the error rate in recording a test case is further reduced.

In an embodiment, the method further includes:
in response to the record starting operation, sending an alert to a user in a case where none of the case labels is selected.

It can be understood that in a case where the user starts the recording but does not select any case label, it is impossible to determine the case information corresponding to the test action data used for recording, thus the test case cannot be generated correctly. By sending the alert to the user, the error rate in recording the test case can be reduced.

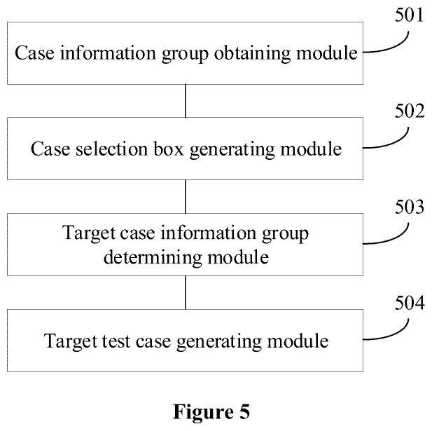

Hereinafter described is an apparatus for testing a test case according to an embodiment of the present disclosure. Cross reference may be made between the apparatus described below and the method for recording a test case described above. As shown in FIG. 5, the apparatus for recording a test case of the present disclosure may include a case information group obtaining module 501, a case selection box generating module 502, a target case information group determining module 503, and a target test case generating module 504.

The case information group obtaining module 501 is configured to obtain, from a pre-established test case management system, case information groups corresponding to a target application program, where each of the case information groups includes a case label and a case requirement.

The case selection box generating module 502 is configured to generate a case selection box by using case labels from the case information groups as candidates.

The target case information group determining module 503 is configured to determine, in response to a record starting operation of a user and in a case where one of the case labels is selected, a target case information group corresponding to the selected case label from the case information groups, and obtain test action data.

The target test case generating module 504 is configured to stop obtaining of the test action data in response to a record stopping operation of the user, and generate a target test case based on obtained test action data and the target case information group.

In an embodiment, the case information group obtaining module 501 includes a functional identification determining unit and a case information group obtaining unit.

The functional identification determining unit is configured to determine test versions of the target application program, and determine, from the test case management system, functional identifications corresponding to the test versions.

The case information group obtaining unit is configured to extract, for each of the functional identifications, case information groups corresponding to the functional identification from the test case management system.

In an embodiment, the case selection box generating module 502 includes a case label sorting unit and a case selection box generating unit.

The case label sorting unit is configured to extract case labels from the case information groups, and sort the case labels based on case numbers in the case labels.

The case selection box generating unit configured to generate the case selection box by using the sorted case labels as candidates.

In an embodiment, the target case information group determining module 503 includes a probe detecting unit and a target function name recording unit.

The probe detecting unit is configured to detecting multiple probes preset in the target application program, where each of the probes is configured to identify a function name in the target application program.

The target function name recording unit is configured to determine, in a case where a target executable statement in the target application program is executed, a target probe corresponding to the executable statement and record a target function name corresponding to the target probe, where the target executable statement is an executable statement in a function module of the target application program.

In an embodiment, the apparatus for recording a test case further includes a correlation establishing module.

The correlation establishing module is configured to establish, based on the recorded target function name, a correlation between the recorded target function name and the target test case, and calculate a percentage of the number of recorded target function names to a total number of all target function names, to obtain a test coverage of the target test case.

In an embodiment, the apparatus for recording a test case further includes a case information content displaying module.

The case information content displaying module is configured to determine, in a case where one of the case labels is selected, a target case information group corresponding to the selected case label from the case information groups, and display case information content of the target case information group in the case selection box.

In an embodiment, the apparatus for recording a test case further includes an alert sending module.

The alert sending module is configured to send, in response to the record starting operation, an alert to a user in a case where none of the case labels is selected.

A storage medium is further provided in an embodiment of the present disclosure. The storage medium stores a computer-readable instruction. The computer-readable instruction, when executed by one or more processors, causes the one or more processor to perform the method for recording a test case according to any of the above embodiments.

A computer device is further provided in an embodiment of the present disclosure. The computer device stores a computer-readable instruction. The computer-readable instruction, when executed by one or more processors, causes the one or more processor to perform the method for recording a test case according to any of the above embodiments.

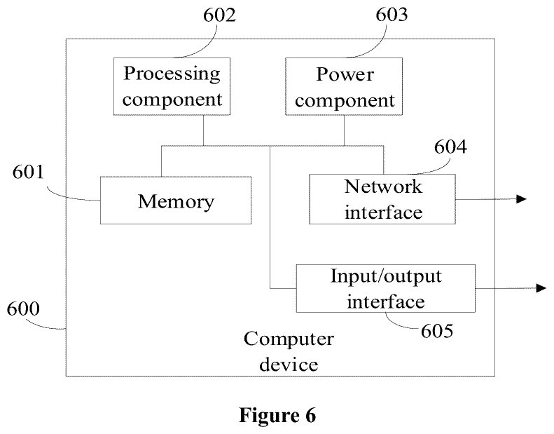

Reference is made to FIG. 6, which is a schematic diagram of an internal structure of a computer device according to an embodiment of the present disclosure. As shown in FIG. 6, the computer device 600 may be provided as a server. Referring to FIG. 6, the computer device 600 includes: a processing component 602 which includes one or more processors; and memory resources represented by a memory 601 for storing an instruction (such as an application program) executable by the processing component 602. The application program stored in the memory 601 may include one or more modules each corresponding to a set of instructions. In addition, the processing component 602 is configured to execute the instruction to perform the method for recording a test case according to any of the above embodiments.

The computer device 600 may further include a power component 603 configured to perform power management for the computer device 600, a wired or wireless network interface 604 configured to connect the computer device 600 to a network, and an input/output (I/O) interface 605. The computer device 600 may operate an operating system based on the memory 601. For example, the operating system is the Windows Server™, Mac OS X™, Unix™, Linux™, Free BSD™, or the like.

Those skilled in the art may understand that the structure shown in FIG. 6 is merely a block diagram of a portion of the structure related to the present disclosure, and does not constitute a limitation on the computer device to which the present solution is applied. The computer device may specifically include more or fewer components than shown in the figure, or have a combination of certain components, or have different component arrangements.

It should be further noted that in the present disclosure, the relationship terminologies such as “first” and “second” are only used to distinguish one entity or operation from another entity or operation, rather than to necessitate or imply an actual relationship or order between the entities or operations. Moreover, terms of “include”, “comprise” or any other variants are intended to be non-exclusive. Therefore, a process, method, article or device including a series of elements includes not only the elements but also other elements that are not enumerated, or further includes elements inherent to the process, method, article or device. Unless expressively limited otherwise, the statement “comprising (including) one . . . ” does not exclude existence of other similar elements in the process, method, article or device. In this specification, words “one”, “a (an)”, “the”, “said” and “that” may include plural forms, unless the context clearly indicates otherwise. “Multiple” refers to a quantity of at least two, such as two, three, five, or eight. The “and/or” includes any and all combinations of related listed items.

The embodiments in the present disclosure are described in a progressive manner, and each of the embodiments focuses on its differences from the other embodiments. Various embodiments may be combined with each other as needed. The same or similar parts among the embodiments may be referred to each other.

The above description of the disclosed embodiments enables those skilled in the art to implement or use the present disclosure. Various modifications to the embodiments are apparent to those skilled in the art, and the generic principles defined herein may be practiced in other embodiments without departing from the spirit or scope of the present disclosure. Therefore, the present disclosure is not to be limited to the embodiments shown herein but is to be conformed with the widest scope consistent with the principles and novel features disclosed herein.

1. A method for recording a test case, performed by a processor, comprising:
determining test versions of a target application program and determining, from a pre-established test case management system, functional identifications corresponding to the test versions and case information groups corresponding to the functional identifications, wherein each of the case information groups comprises a case label and a case requirement;
extracting case labels from the case information groups, and sorting the case labels based on case numbers in the case labels, and generating a case selection box by using the sorted case labels as candidates;
determining, in response to a record starting operation of a user and in a case where one of the case labels is selected, a target case information group corresponding to the selected case label from the case information groups, and obtaining test action data, wherein the obtaining test action data comprises:
detecting a plurality of probes preset in the target application program, wherein each of the probes is configured to identify a function name in the target application program; and
determining, in a case where a target executable statement in the target application program is executed, a target probe corresponding to the target executable statement and recording a target function name corresponding to the target probe, wherein the target executable statement is an executable statement in a function module of the target application program; and
stopping obtaining the test action data in response to a record stopping operation of the user, and automatically generating a target test case based on the obtained test action data and the target case information group without requiring the user to manually input test case IDs;
wherein after the step of stopping obtaining the test action data in response to a record stopping operation of the user, and generating a target test case based on obtained test action data and the target case information group, the method further comprises:
establishing, based on the recorded target function name, a correlation between the recorded target function name and the target test case; and
calculating a percentage of a number of recorded target function names to a total number of all target function names, to obtain a test coverage of the target test case; and
wherein the method further comprises:
determining, in a case that one of the case labels is selected, a target case information group corresponding to the selected case label from the case information groups; and
displaying, in the case selection box, case information content in the target case information group.

2. (canceled)

3. (canceled)

4. The method for recording a test case according to claim 1, further comprising:
determining, in a case that one of the case labels is selected, a target case information group corresponding to the selected case label from the case information groups; and
displaying, in the case selection box, case information content in the target case information group.

5. The method for recording a test case according to claim 1, further comprising:
sending, in response to the record starting operation, an alert to a user in a case where none of the case labels is selected.

6. (canceled)

7. (canceled)

8. A non-transitory computer-readable storage medium, wherein the storage medium stores a computer-readable instruction, and the computer-readable instruction, when executed by one or more processors, causes the one or more processor to perform the method for recording a test case according to claim 1.

9. A computer device, comprising: one or more processors and a memory, wherein
the memory stores a computer-readable instruction, and
the computer-readable instruction, when executed by the one or more processors, performs the method for recording a test case according to claim 1.
